(19) United States
(12) Patent Application Publication
(10) Pub. No.: US 2007/0006052 A1
(43) Pub. Date: Jan. 4, 2007

(54) Method for storing information on an optical disc

(76) Inventor: Martinus Wilhelmus Blum, EINDHOVEN (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,390

(22) PCT Filed: Dec. 3, 2003
(86) PCT No.: PCT/IB03/05699

§ 371 Date: Jun. 15, 2005

(30) Foreign Application Priority Data
Dec. 20, 2002 (EP) 02080516.4

(51) Int. Cl. G06K 5/04

(52) U.S. Cl. 714/699

(57) ABSTRACT

A method is described for storing information on an optical disc, wherein data is encoded to form ECC blocks, and wherein the ECC blocks are written in predefined writing zones (Z) between run-in/run-out fields. According to the present invention, two or more ECC blocks are written between a run-in field and a run-out field.

### FIELD OF THE INVENTION

The present invention relates in general to a method of storing information on an optical disc. More specifically, the present invention relates to a storage method according to a standard where ECC blocks are written between run-in/run-out fields.

Further, the present invention relates to a disc drive apparatus for writing/reading information into/from an optical storage disc; hereinafter, such disc drive apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. Such disc can be of a write-once type, which can only be written once, or of a rewritable type, which can be written many times. Specifically, the present invention relates to the field of rewritable discs, although the scope of the invention is not limited to this field since the features of the invention are also applicable to other types of disc. Since the technology of optical discs in general, the way in which information can be stored in an optical disc, and the way in which optical data can be read from an optical disc, is commonly known, it is not necessary here to describe this technology in more detail.

When storing information on a record medium, the information is coded in data words in accordance with a predetermined format. For different applications, different formats exist. One general problem is that, on writing and/or on reading, errors may happen, so that the date read back from a recording is not identical to the original data. This is undesirable. Therefore, error-correction schemes have been developed, capable of correcting data errors to a certain extent. Such error-correction schemes involve the addition of error correction bits to the original data. In a particular class of error-correction schemes, a predefined amount of original data and error-correction bits are mixed together, according to a predefined algorithm. The combination forms an Error Correction Code block (ECC block). An ECC block contains a predetermined amount of data If the amount of data to be stored is larger than the data capacity of one ECC block, the data is written in a plurality of ECC blocks.

Since coding schemes for ECC blocks are known to a person skilled in the art, while further the present invention is not related to the coding scheme as such, a detailed discussion of a coding algorithm will be omitted here. By way of example, reference is made to the DVD standard ECMA 267: “120 mm DVD—Read Only Disc”, December 1997, Section 4 “Data Format”.

However, it is noted that each ECC block is to be regarded as a unit of coded information, i.e. for reading information back it is not sufficient to read just a portion of an ECC block: the block needs to be read and treated as a whole, because the decoding algorithm needs to have all data from the block. Thus, it is only possible to decode the block as a whole.

In some formats, it is expected that blocks are written in a substantially continuous stream behind each other; DVD is an example of such format. Other formats exist, which allow a user to write any block at any desired address on disc; BluRay is an example of such format. The present invention relates specifically to the latter type of format, which will hereinafter be indicated as “Random Acces” (RA) format. When writing or reading such a block, a disc drive needs to know where to start and to stop, and needs to become “synchronized” to the physical track. Usually, this is done by reading previously stored information when approaching the target location; however, in an RA format, it may very well be that the track is still empty, so there is no information to synchronize with. On the other hand, even if the previous location were not empty, it would be very difficult to immediately start writing from the end of the previous block.

In order to overcome this problem, an RA format requires that a so-called run-in field be placed before a data fragment to be recorded, and that a so-called run-out field be placed after such a data fragment. Thus, two subsequently recorded data fragments are separated by a sequence of run-out field and run-in field, which provides a margin necessary for error-free linking. Hereinafter, these fields will be indicated as RIF and ROF, respectively.

The run-in and run-out fields occupy storage space on disc. Therefore, one object of the present invention is to increase the data storage capacity of discs.

There is a trend towards reducing physical dimensions of data storage equipment. Recently, a disc drive for small discs (SFFO) is under development, suitable for implementation in mobile apparatus like mobile telephone, Personal Digital Assistant (PDA), etc. In such application, the discs will be much smaller than discs according to current formats, and for technical reasons it may be desirable that the prescribed block length is smaller than in current formats. On the other hand, it is desirable to use, for such small SFFO discs, a format that is very similar to an existing format. One reason is that it takes a lot of time to develop a new format. Another reason is that, when two formats are similar, also the corresponding decoders are similar, and it becomes easier to develop a new decoder for a new format starting from a known decoder for the known format. It is especially desirable to use, for such small SFFO discs, an addressing format identical to an existing format, while further being compatible with such existing format on the level of the wobble channel.

An important objective of the present invention is to provide such a new format.

Further, it is desirable if a disc can be accessed by two (or more) different formats. Up till now, each storage portion of a disc is initially formatted in accordance with one format only. Then, if a disc is to be used with two different formats, the disc must be partitioned on initialization, for instance in a first radial portion where all blocks are formatted according to one format and a second radial portion where all blocks are formatted according to a second format. Alternatively, first and second block types may be arranged alternatingly on the same track.

An important objective of the present invention is to format a disc in such a way that blocks can be used by two (or more) formats.

### SUMMARY OF THE INVENTION

According to an important aspect of the present invention, two or more ECC blocks are written between a RIF and a ROF. Specifically, these two ECC blocks are placed directly behind each other. Thus, no ROF/RIF pair is present between these two ECC blocks. During a write operation, both ECC blocks are written, together with the RIF and the ROF. During a read operation, each individual block can be read independently from the other.

According to a further important aspect of the present invention, a write operation comprises the step of either placing one large ECC block or placing a plurality of smaller ECC blocks between two run-in and run-out fields, according to the format being used. Thus, a certain location on disc is no longer allocated to one specific format.

### BRIEF DESCRIPTION OF THE DRAWINGS

These and other aspects, features and advantages of the present invention will be further explained by the following description of a preferred embodiment of the method according to the present invention with reference to the drawings, in which same reference numerals indicate same or similar parts, and in which:

FIGS. 1-4 are diagrams illustrating storage space of a disc, specifically illustrating block length in relation to storage zone length;

FIG. 5 is a block diagram schematically illustrating a disc drive apparatus;

FIG. 6 is a block diagram illustrating a double-block writing operation of a controller according to the present invention; and

FIGS. 7A and 7B are block diagram illustrating reading operations of a controller according to the present invention.

### DESCRIPTION OF THE INVENTION

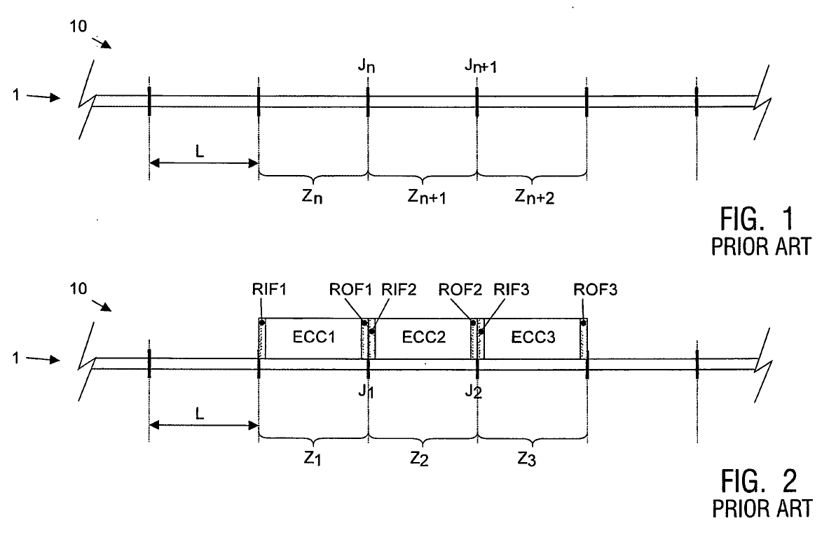

An optical storage disc 1 comprises at least one track, either in the form of a continuous spiral or in the form of multiple concentric circles, of storage space 10 where information may be stored in the form of a data pattern. This storage space 10 is physically present on the disc, arranged in the manufacturing process of the disc. Directly after manufacturing, the storage space 10 is still empty, i.e. it contains no data written. FIG. 1 schematically shows a part of the storage space 10, visualized as a continuous ribbon, for a case where the disc 1 is such a blank disc.

In a blank disc for use with a random access format, not only the tracks are present, but the tracks also have already a structure corresponding to locations where blocks of data are to be stored. In an example, the disc may comprise a wobble channel (not shown in FIG. 1) physically arranging the tracks as a series of subsequent storage zones Z. Other methods for defining storage zones are possible also. In the following, storage zones in general will be indicated as Z, while individual storage zones will be distinguished by the addition of index n, n+1, n+2, etc. Likewise, a junction between two adjacent zones will generally will be indicated as J, while individual junctions will be distinguished by the addition of index n, n+1, n+2, etc.

Since the predetermined arrangement of a track into a plurality of storage zones Z during manufacturing, and the use of the wobble channel as an example of defining storage zones, are known to persons skilled in this art, while further such division as such is not the subject of the present invention, further details in this respect are omitted here.

The disc 1 is intended for use with a predetermined format which describes, inter alia, the structure of the blocks to be written. More particularly, such format describes the number of bytes of data and the number of error correction bits in each block, i.e. the number of bits in each block, which in turn, in conjunction with the required space for writing one bit, determines the physical length L of the zones Z. Typically, the BluRay format provides a block length of 64 kbyte of user data. It is noted that the data bytes and the correction bits belong together and form an inseparable Error Correction Code block or ECC block. On retrieval of the data, a decoder needs to have all data bits and all error correction bits of an ECC block in order to be able to decode any single data byte. Hereinafter, the size of an ECC block will be indicated in terms of data; thus, in view of the presence of the error correction bits, an ECC block is actually larger than the size mentioned (64 kbyte).

Examples of present day formats are DVD-RW, DVD-ROM, CD-RW, CD-ROM, BluRay-RW, BluRay-ROM, etc. BluRay is a rather recent format which allows individual ECC blocks to be written in any desired storage zone Z of the disc (provided, of course, that the zone is not damaged or occupied). In order to enable the writing means of a disc drive apparatus to correctly write the entire contents of an ECC block, and in order to enable the reading means of a disc drive apparatus to correctly read the entire contents of an ECC block, the BluRay format prescribes the use of a run-in field (RIF) before and a run-out field (ROF) after each ECC block. Therefore, the physical length L of the zones Z corresponds to the overall length of one ECC block plus one RIF plus one ROF.

Since the notion of RIF/ROF is known to persons skilled in this art, while the design and contents of such RIF/OF is also known to persons skilled in this art, a more detailed discussion thereof is omitted here.

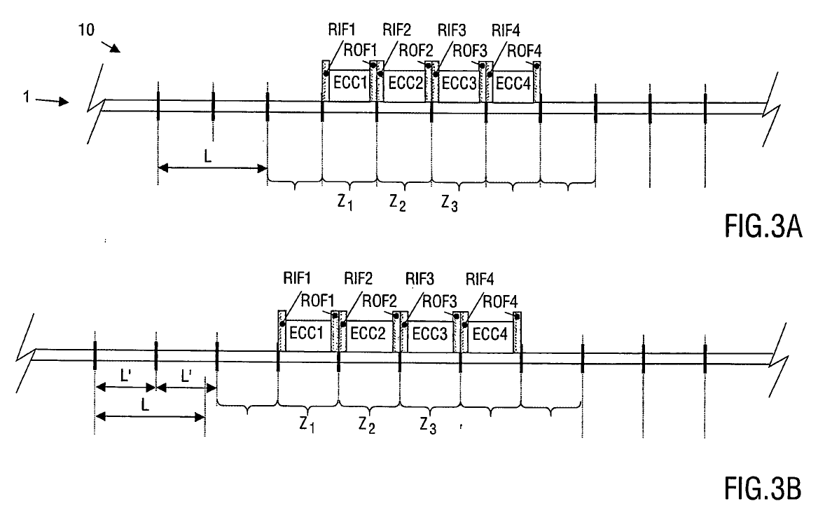

FIG. 2 is a drawing similar to FIG. 1, schematically illustrating a part of the storage space 10 having three ECC blocks ECC1, ECC2, ECC3 written in adjacent storage zones Z1, Z2, Z3, respectively. Each ECC block ECCi is flanked by a RIFi/ROFi pair, respectively, i being 1, 2, 3. It can clearly be seen in FIG. 2 that the combination of RIF1, ECC1, ROF1 fits precisely in the first zone Z1. Further, it can be recognized in FIG. 2 that the combination of ROF1 and RIF2 provides a margin between ECC1 and ECC2 at the junction J1 between Z1 and Z2.

It is desirable to be able to use smaller ECC blocks. One possible reason for this is that, for reading a small amount of data, the entire ECC block needs to be read, which takes time; in the case of a smaller ECC block, the data is available quicker than in the case of a larger ECC block. Another reason is that small discs, such as the SFFO disc, are so small that, in an inner area of the disc, the length of 360° track portions is smaller than L for existing 64 kbyte blocks of the BluRay format, which reduces the error correction capabilities. If smaller blocks would be used, for instance 32 kbyte blocks, the length would be shorter than a 360° track portion. Although the error correction capabilities of a 32 kbyte block is smaller than the error correction capabilities of a 64 kbyte block if both blocks are in the same condition (length shorter than a 360° track portion), the error correction capabilities in the case of a 32 kbyte block having a length shorter than a 360° track portion are better than the error correction capabilities in the case of a 64 kbyte block having a length larger than a 360° track portion.

One possible way of meeting this desire is to manufacture discs in which the length of the storage zones Z is made smaller, in accordance with the length of the smaller ECC blocks. However, this would involve developing a new wobble channel. Further, the disc would no longer be suitable for storing larger blocks. A further disadvantage would be that the overall storage capacity of the disc may be reduced.

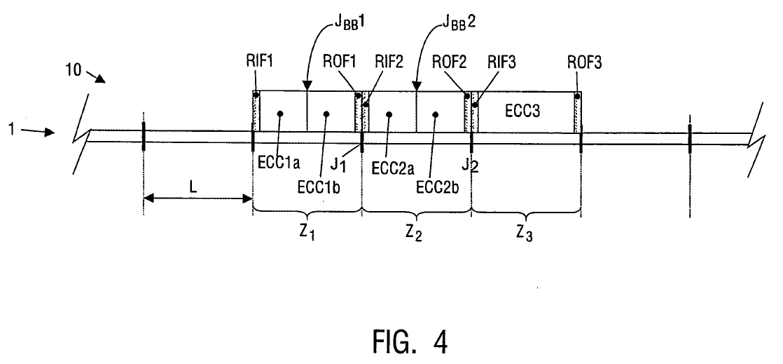

These disadvantages are illustrated in FIGS. 3A-B, which are drawings similar to FIG. 2, but now the length of the ECC blocks is reduced by half. In FIG. 3A, the length of the storage zones is also reduced by half (L indicates the original length—see FIG. 1). Since the original length L of one storage zone Z should now accommodate two ECC blocks and two RIF/ROF pairs, while the length of each RIF/ROF pair remains the same, the length of the “new” ECC blocks is inevitably smaller than half the length of the original ECC block. This translates into fewer correction bits.

In FIG. 3B, the length of the ECC blocks is exactly 50% of the length of the original blocks. Assume, for the sake of discussion, that the error correction capabilities of these smaller blocks are exactly the same as the error correction capabilities of the original larger blocks of FIG. 1. Since two of these half-blocks are associated with a total of two RIF/ROF pairs, the length L′ of the storage zones is inevitably larger than half the length L of the original storage zones. This translates into fewer zones on disc, therefore fewer data. Further, in view of the discrepancy between L′ and L, the wobble channel should be amended.

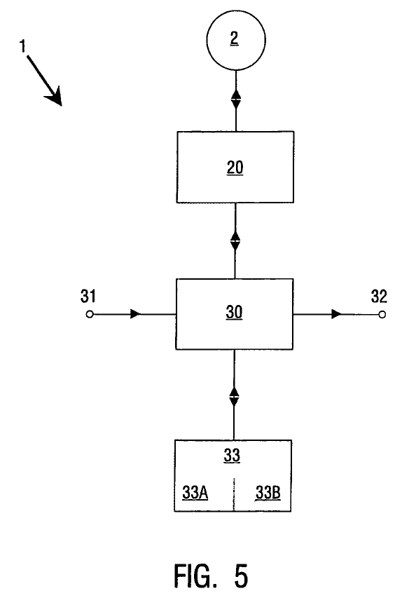

FIG. 4 is a drawing similar to FIG. 2, illustrating the inventive proposal of the present invention. The length L of the zones Z is the same as in FIG. 1 and 2. In the first storage zone Z1, two smaller blocks ECC1a and ECC1b are written, directly behind each other, between one RIF/ROF pair RIF1/ROF1. More particularly, a first run-in field RIF1 precedes the first block ECC1a, and a first nm-out field ROF1 follows the second block ECC1b. A junction between these two ECC blocks ECC1a and ECC1b is indicated as J_{BB}1. In this case, the overall length of the two smaller blocks ECC1a and ECC1b is exactly equal to the original length of block ECC1 (FIG. 2).

In a similar manner, the second storage zone Z2 contains two blocks ECC2a and ECC2b, directly behind each other, between one RIF/ROF pair RIF2/ROF2.

Thus, the present invention succeeds in providing a data storing format where ECC blocks are associated with run-in and run-out fields, where the length of the ECC blocks has been reduced without reduction of the data storage capacity, without amending the wobble channel, while the address format can be maintained. A further advantage obtained by the present invention is that, for situations where the distance between one run-in field and the corresponding next run-out field is larger than a 360° track portion, the error correction capabilities have improved by the reduction in ECC block length.

An important advantage is that a disc can now be written using any of two different formats, one providing smaller ECC blocks than the other. Thus, it is not necessary to manufacture two different types of discs.

Another important advantage is that even one specific disc can contain ECC blocks of both formats, i.e. having mutually different length. This is also illustrated in FIG. 4, where the third zone Z3 is shown containing one large ECC block ECC3. In other words, it is possible to write in one specific storage zone either one large block according to a first format or two smaller blocks according to a second format, as desired. If a zone has been written according to one type of format, this zone is not restricted to this one type of format only: as soon as this zone becomes available for writing again, it is possible to write this zone according to the other type of format.

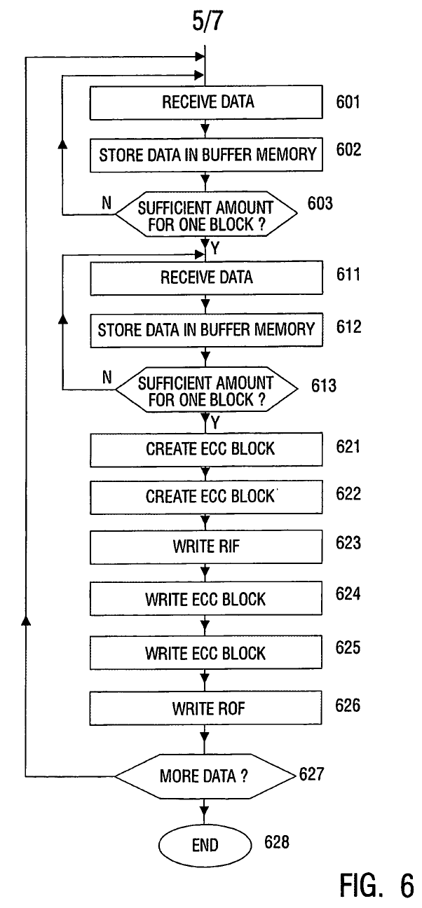

FIG. 5 is a block diagram schematically illustrating a disc drive apparatus 1 for storing data on an optical disc 2 and for reading data from the disc 2. The disc drive apparatus 1 comprises read/write means 20, which may be prior art read/write means, as will be clear to a person skilled in the art. The disc drive apparatus 1 further comprises a controller 30 which controls the read/write means 20. The controller 30 has an input 31 for receiving data to be stored from any source, and has an output 32 for outputting data read from disc. The controller 30 is designed for operation in accordance with a predefined format, as will be clear to a person skilled in the art.

In a preferred embodiment, the controller 30 according to the present invention is capable of operating in two different writing modes, a first writing mode or single block writing mode for writing single ECC blocks in the selected writing zones in accordance with one format, and a second writing mode or double-block writing mode for writing two ECC blocks in the selected writing zones in accordance with a second format.

When in a reading mode, a prior art controller would approach a selected zone, would recognize an RIF, and would start reading an ECC block directly after the end of the RIF. The prior art controller would continue reading the ECC block until it recognizes an ROF, or until it finds that a predetermined amount of data, corresponding to one ECC block, has been read. It is noted that a controller operating according to the first format, for instance a prior art controller or an inventive controller operating in a single block reading mode, would be capable of reading single blocks (such as block ECC3 in zone Z3 of FIG. 4) from a disc written in accordance with the present invention.

A controller 30 according to the present invention is designed for reading any of the double blocks written in one zone Z. It is possible that the controller 30 is selectively operating in either a single block reading mode or a double block reading mode. In a single block reading mode, the controller 30 is capable of reading an ECC block (ECC3) from an RIF to an ROF, as in prior art. In a double block reading mode, the controller 30 is capable of reading either an ECC block (ECC1a) from an RIF to a block-block transition, or reading an ECC block (ECC1b) from a block-block transition to an ROF. The controller 30 may be designed to recognize a block-block transition from the addresses mentioned in the data read by the controller, but it is also possible that the controller 30 is designed to count the amount of data read, starting from the corresponding RIF, and to decide that a block-block transition is reached if a predetermined amount of data, corresponding to one block, has been read. A combination of both methods is also possible: while reading, the controller 30 counts the amount of data; when this amount approaches the amount corresponding to one block, indicating that a block-block transition is to be expected, the controller 30 starts interpreting to data in order to recognize the transition.

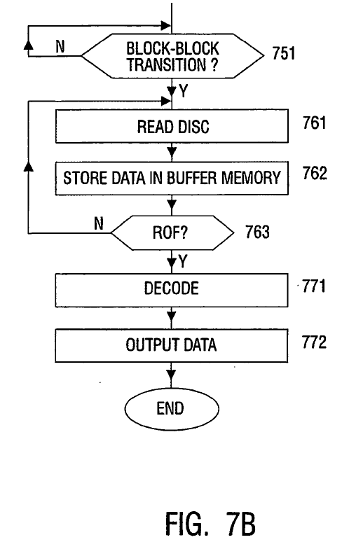

FIG. 7A is a block diagram illustrating a reading operation 700 of a controller 30 according to the present invention, for reading a first one of the double blocks written in one zone Z, such as for instance block ECC1a. FIG. 7B is a block diagram illustrating a reading operation 700 of a controller 30 according to the present invention, for reading a second one of the double blocks written in one zone Z, such as for instance block ECC1b.

As illustrated in FIG. 7A, the controller 30 approaches the target zone, reading the information stored in the disc. The controller 30 checks (step 701) whether the data pattern indicates an RIF. If the controller 30 has recognized an RIF, it will start reading (step 721) the ECC block following the RIF, and it will store (step 722) the block information in memory 33. The controller 30 checks (step 723) whether the data pattern indicates an RIF, and the controller 30 checks (step 724) for a block-block transition. If both test results are negative, the controller 30 jumps back to step 721 and continues reading the disc.

If the controller 30 has recognized an ROF or a block-block transition, the controller 30 goes on to decode the data in memory 33 (step 731), and outputs the decoded data at its output 32 (step 732).

It is noted that recognizing a block-block transition (step 724) may involve counting data amount during reading (step 721) or storing (step 722) data, but may also involve interpreting the data for addresses.

As illustrated in FIG. 7B, the controller 30 approaches the target zone, reading the information stored in the disc. The controller 30 checks (step 751) for a block-block transition. If the controller 30 has recognized a block-block transition, it will start reading (step 761) the ECC block following the block-block transition, and it will store (step 762) the block information in memory 33. The controller 30 checks (step 763) whether the data pattern indicates an ROF. If the test result is negative, the controller 30 jumps back to step 761 and continues reading the disc.

If the controller 30 has recognized an ROF, the controller 30 goes on to decode the data in memory 33 (step 771), and outputs the decoded data at its output 32 (step 772).

It is noted that recognizing a block-block transition (step 751) may involve counting data amount during reading data, but may also involve interpreting the data for addresses.

It should be clear to a person skilled in the art that the present invention is not limited to the exemplary embodiments discussed above, but that various variations and modifications are possible within the protective scope of the invention as defined in the appending claims.

In the above, the two “smaller” blocks ECC1a and ECC1b are described as having equal length, for instance 32 kbyte. Although this is preferred, it is not essential.

Further, the present invention is not restricted to writing two ECC blocks in one storage zone. The number of blocks may be larger, in which case the length of the blocks will decrease. For instance, it is possible to write four ECC blocks (16 kbyte each) in one storage zone.

Further, the present invention is not restricted to writing an integer number of ECC blocks in one storage zone. It is possible to use two or more storage zones for writing an integer number of ECC blocks. For instance, it is possible to write three ECC blocks in two storage zones.

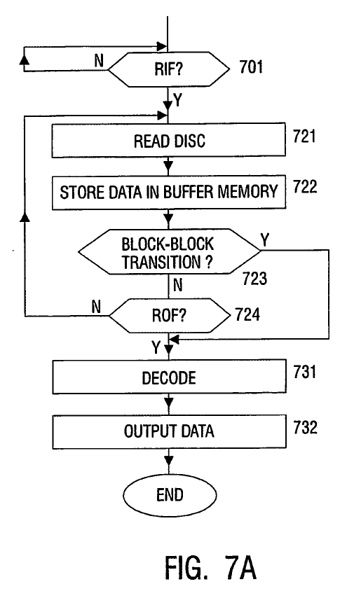

With reference to FIG. 6, an example of a writing method is discussed where data is received and stored in a buffer memory (steps 601, 602; 611, 612), after which ECC blocks are created (steps 621 and 622), after which RIF, two ECC blocks and ROF are written in one run. Alternatively, an ECC block may already be created while data is being received. Also, it is not necessary to wait with writing until both blocks have been received: alternatively, after the first ECC block has been received, it is possible to start writing RIF and first ECC block while data for the second ECC block is being received, if it can safely be assumed that the second ECC block is ready for writing when the writing process of the first ECC block is completed so that writing may continue seamlessly.

Likewise, it is not necessary to wait with receiving new data (step 601) until all data has been written (step 623-626), but it is possible to start receiving data and filling the first buffer memory 33A when all information from first buffer memory 33A has been written (step 624 completed).

1. Method for storing information on an optical disc, the disc comprising at least one track having predefined storage zones having a predefined storage capacity; the method comprising the steps of:
coding a first predetermined amount of data into an ECC block according to a predefined format,
generating a run-in field,
generating a run-out field,
and consecutively writing the RIF, writing the ECC block after the RIF, and writing the ROF after the ECC block;
characterized by:
coding a second predetermined amount of data into a second ECC block according to said predefined format,
and writing the second ECC block adjacent the first ECC block.

2. Method according to claim 1, wherein the second ECC block is written between the first ECC block and the ROF.

3. Method according to claim 1, wherein the second ECC block is written between the RIF and the first ECC block.

4. Method according to claim 1, wherein, between one RIF and the first following ROF, a plurality of at least two ECC blocks is written.

5. Method according to claim 4, wherein a sequence of said one RIF, said plurality of ECC blocks, and said first following ROF, is written within one storage zone.

6. Method according to claim 4, wherein a sequence of said one RIF, said plurality of ECC blocks, and said first following ROF, is written within a plurality of storage zones.

7. Method according to claim 4, wherein a first plurality of sequences, each sequence consisting of one RIF, a second plurality of ECC blocks, and the respective first following ROF, is written within a third plurality of storage zones.

8. Method according to claim 4, wherein a sequence of said one RIF, said plurality of ECC blocks, and said first following ROF, is consecutively written in one writing action.

9. Optical disc, comprising at least one track having predefined storage zones having a predefined physical storage length;
the optical disc containing at least one sequence consisting of one RIF, a plurality of ECC blocks adjacent each other, and the first following ROF.

10. Optical disc according to claim 9, wherein said sequence is contained in one zone.

11. Optical disc, comprising at least one track having predefined storage zones having a predefined physical storage length;
the optical disc containing at least one sequence consisting of one RIF, a plurality of ECC blocks adjacent each other, and the first following ROF, containing information stored in accordance with the method according to claim 1.

12. Optical disc according to claim 9,
the optical disc containing at least a first sequence consisting of one RIF, a first plurality of ECC blocks adjacent each other, and the first following ROF;
the optical disc containing at least a second sequence consisting of one RIF, a second plurality of ECC blocks adjacent each other, and the first following ROF;
wherein the second plurality comprises a different number of ECC blocks as compared to said first plurality.

13. Method for reading information from a disc according to claim 9, comprising the steps of:
recognizing an RIF as signaling the beginning of an ECC block;
reading an ECC block, until a block-block transition is recognized as signaling the end of the ECC block;
decoding the ECC block read between RIF and block-block transition;
outputting the decoded data.

14. Method for reading information from a disc according to claim 9, comprising the steps of:
recognizing a block-block transition as signaling the beginning of an ECC block;
reading an ECC block, until a block-block transition is recognized as signaling the end of the ECC block;
decoding the ECC block read between the two block-block transitions;
outputting the decoded data.

15. Method for reading information from a disc according to claim 9, comprising the steps of:
recognizing block-block transition as signaling the beginning of an ECC block;
reading an ECC block, until an ROF is recognized as signaling the end of the ECC block;
decoding the ECC block read between block-block transition and ROF;
outputting the decoded data.

16. Disc drive apparatus, designed for performing the method according to claim 1.

17. Disc drive apparatus according to claim 16, comprising a controller capable of selectively operating in either a first writing mode or single block writing mode for writing single ECC blocks in selected writing zones in accordance with one format, or in a second writing mode or double-block writing mode for writing a predetermined number of ECC blocks in selected writing zones in accordance with a second format, said predetermined number being two or more.

18. Disc drive apparatus according to claim 16, comprising a controller capable of selectively operating in either a first reading mode or single block reading mode for reading a single ECC block from an RIF to an ROF in a selected reading zone in accordance with one format, or in a second reading mode or double-block reading mode for reading a single ECC block from an RIF to a block-block transition, or from a block-block transition to an ROF, or from a block-block transition to a block-block transition, in a selected reading zone in accordance with a second format.
